(19) United States
(12) Patent Application Publication
(10) Pub. No.: US 2006/0261192 A1
(43) Pub. Date: Nov. 23, 2006

(54) Robotic paint applicator and method of protecting a paint robot having an explosion proof electric motor

(75) Inventors: Jurgen Haas, Knittlingen (DE); Thomas Hezel, Asperg (DE); Marcus Frey, Weil der Stadt (DE)

Correspondence Address: YOUNG & BASILE, P.C., 3001 WEST BIG BEAVER ROAD, SUITE 624, TROY, MI, 48084, US

(73) Assignee: DURR SYSTEMS, INC., Auburn Hills, MI (US)

(21) Appl. No.: 11/404,553

(22) Filed: Apr. 14, 2006

Related U.S. Application Data
(60) Provisional application No. 60/671,586, filed on Apr. 15, 2005.

(51) Int. Cl. B05B 1/30

(52) U.S. Cl. 239/533.1

(57) ABSTRACT

A robotic paint applicator and a method of protecting a paint robot having an explosion proof electric motor. A plurality of electric motors are enclosed by a substantially air-tight motor housing and have a gas inlet and a gas outlet. A robot enclosure is also substantially air-tight and houses at least one electric motor. A source of non-combustible gas supplies gas at pressures sufficient to purge and to maintain positive non-combustible gas pressures. The plurality of electric motors is serially connected and receives gas through a first gas inlet. A first discharge conduit is coupled to an air outlet of the final electric motor for expelling gas. A second conduit transmits gas from the source to the robot enclosure, and a second discharge conduit expels gas from the robot enclosure. A transfer block separately controls the gas pressures from the source.

### CROSS-REFERENCE TO RELATED APPLICATIONS

This application claims priority to co-pending provisional application Ser. No. 60/671,586, filed on Apr. 14, 2005, which is incorporated herein in its entirety by reference.

### FIELD OF THE INVENTION

The invention relates to a robotic paint application system for use in a potentially explosive atmosphere, such as a paint booth, and a method of protecting a paint robot having an electric motor in such an atmosphere.

### BACKGROUND

In U.S. Pat. No. 6,835,248, which is assigned to the present assignee and is incorporated herein in its entirety by reference, there is taught a robotic paint applicator having a plurality of enclosures each including an explosion proof motor. Each motor includes a housing having a gas inlet and a gas outlet. Non-combustible gas is connected to each of the gas inlets to circulate the gas through the respective motors. Non-combustible gas is also circulated through each robot housing enclosure.

### SUMMARY

As taught herein, a robotic paint applicator can include a plurality of electric motors, each enclosed by a substantially air-tight motor housing and having a gas inlet and a gas outlet. A robot enclosure supports a painting tool, the robot enclosure being substantially air-tight and housing at least one electric motor and its respective motor housing. A source of non-combustible gas is operable to supply gas at gas pressures sufficient to purge each motor housing and the robot enclosure and to maintain positive non-combustible gas pressures within each motor housing and the robot enclosure. A first conduit is coupled the source and to a first gas inlet of a first one of the plurality of electric motors for transmitting gas from the source to the plurality of electric motors. The plurality of electric motors is serially connected such that each gas inlet other than the first gas inlet is coupled to a gas outlet of an adjacent one of the plurality of electric motors. A first discharge conduit is coupled to an air outlet of a final one of the plurality of electric motors for expelling gas from the plurality of electric motors. A second conduit coupled to the source and the robot enclosure transmits gas from the source to the robot enclosure. A second discharge conduit coupled to the robot enclosure expels gas from the robot enclosure. A transfer block separately controls a gas pressure within the motor housings and a gas pressure within the robot enclosure. The transfer block is located between the source and the first conduit and the source and the second conduit.

These and other inventive features are disclosed in more detail below.

### BRIEF DESCRIPTION OF THE DRAWINGS

The description herein makes reference to the accompanying drawings wherein like reference numerals refer to like parts throughout the several views, and wherein:

FIG. 1 is a side cross-sectional view of one example of an explosion proof servomotor utilized in a robotic paint applicator according to the invention;

FIG. 1A is an end elevation view of the explosion proof servomotor shown in FIG. 1;

FIG. 2 is a partially cross-sectioned side view of one embodiment of a robotic paint applicator according to the invention;

FIG. 3 is a partially cross-sectioned side view of the robotic paint applicator shown in FIG. 2 with schematics illustrating the purging system;

FIG. 4 is partially cross-sectioned side view of an alternative embodiment of the robotic paint applicator of this invention;

FIG. 5 is an end view of the robotic paint applicator illustrated in FIG. 4 including schematics illustrating the purging system;

FIG. 6 is a schematic illustration of the purge system utilized in robotic paint applicators taught herein; and

FIG. 7 is a partial schematic illustration of an alternative embodiment of the purge system that may be utilized in robotic paint applicators taught herein.

### DETAILED DESCRIPTION

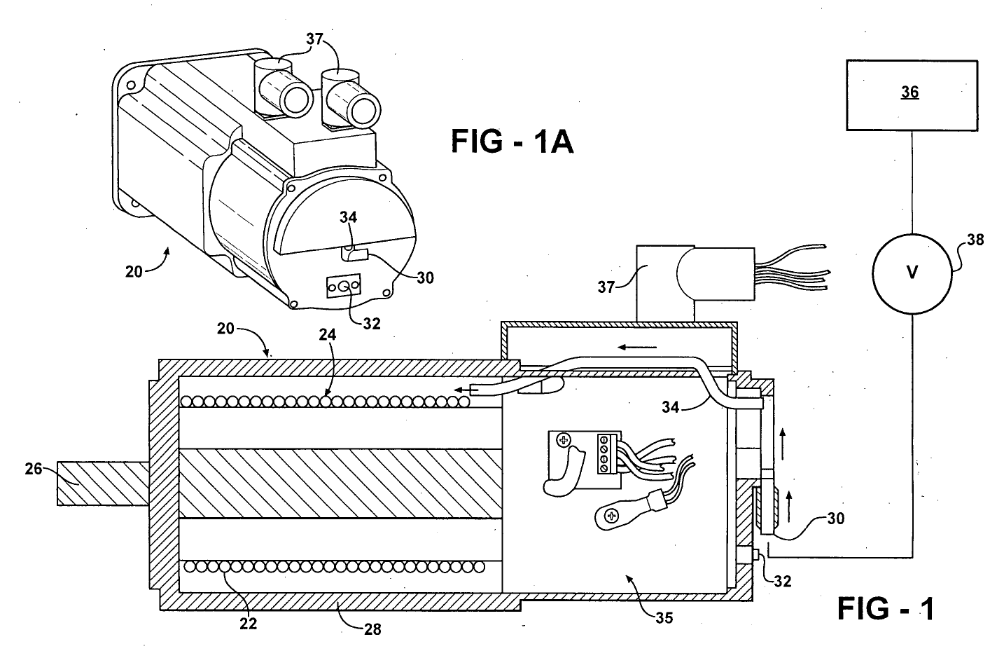

FIGS. 1 and 1A illustrate one embodiment of an explosion proof electric motor 20 adapted for use in a robotic paint applicator as described below. In this example, the explosion proof electric motor 20 is an electric servomotor including a conventional stator 22, rotor 24 and drive shaft 26. The explosion proof electric motor 20 includes a substantially air-tight motor housing 28 including a gas inlet 30 and a gas outlet 32 to maintain a positive non-combustible gas pressure within the housing 28. The gas outlet 32 preferably includes a disc-shaped flame restrictor filter.

The gas inlet 30 is connected to a source of non-combustible gas 36 under pressure, which can be air. The source of non-combustible gas 36 is connected to the inlet 30 through a valve 38. The valve 38 is connected to a control (not shown) that, as described below with regard to a method of protecting a paint robot from explosion, may be utilized to control the volume or pressure of non-combustible gas received by the gas inlet 30 or may be turned off during maintenance or when the paint applicator is idle for an extended period of time. The gas inlet 30 is connected to a tube 34 having an outlet within the electric motor 20 to purge the primary components of the servomotor including the stator 22 and rotor 24 as shown by the arrows in FIG. 1. The non-combustible gas thus circulates through the components of the electric servomotor including the stator 22 and rotor 24 and returns through a junction box 35 containing further electrical components, such as relays, switches and the like.

FIG. 1A is a perspective view of the explosion proof electric motor 20 described above illustrating the gas inlet 30 and the outlet 32 protruding through the motor housing 28. The illustrated embodiment further includes a plurality of conventional electrical connectors 37 that receive the wires to the electrical components (not shown) of the explosion proof servomotor 20, preferably in sealed relation to avoid entry of combustible gas into the motor housing 28.

As described below, the explosion proof electric motor 20 is initially purged of potentially combustible gas by directing air or another non-combustible gas, such as nitrogen, from the source 36 through the valve 38 to the inlet 30 of the electric motor 20. The air under pressure is initially received in the junction box 35 by tube 34, which communicates with the stator 22 and rotor 24. The air is then circulated through the junction box 35 and discharged through the outlet 32 into a robot enclosure containing the electric motor, also purging the enclosure as described below. Alternatively, the air discharged through the outlet 32 is directed into another motor as discussed hereinafter. Following purging, the explosion proof electric motor 20 may be actuated, and the air pressure is then reduced by valve 38 to maintain a positive pressure of non-combustible gas in the housing 28 during operation of the robot as described below. Thus, the motor 20 is properly classified as an explosion proof motor under the Standard for Purged and Pressurized Enclosures for Electrical Equipment in Hazardous (Classified) Locations, MFPA 496-7 for Class I, Division 1 Locations in which ignitable concentrations of flammable gases or vapors exist under normal operating conditions, such as a paint spray booth, because the motor housing is purged with a non-combustible gas and then maintained at a pressure greater than atmospheric pressure pursuant to Chapter 2, 2-2.3.1, supra. Thus, the explosion proof servomotors utilized in the robotic paint applicator of this invention are nonhazardous.

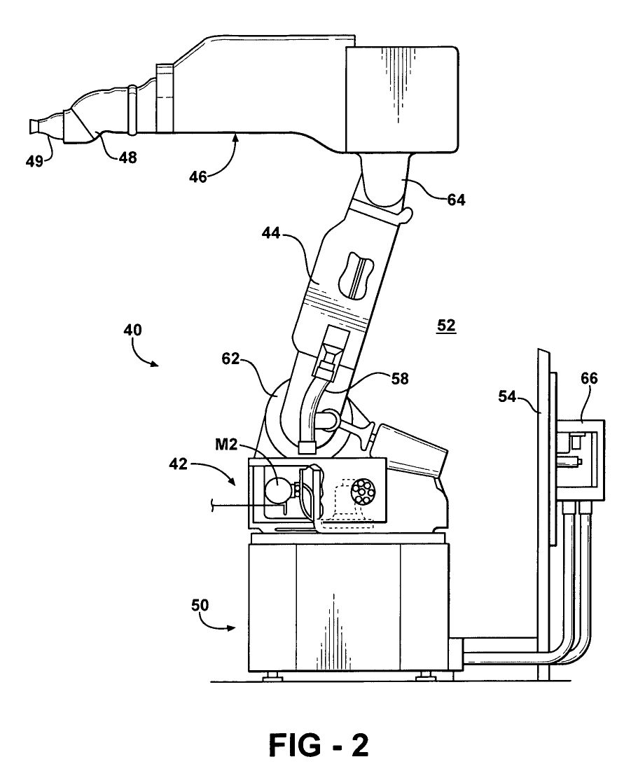

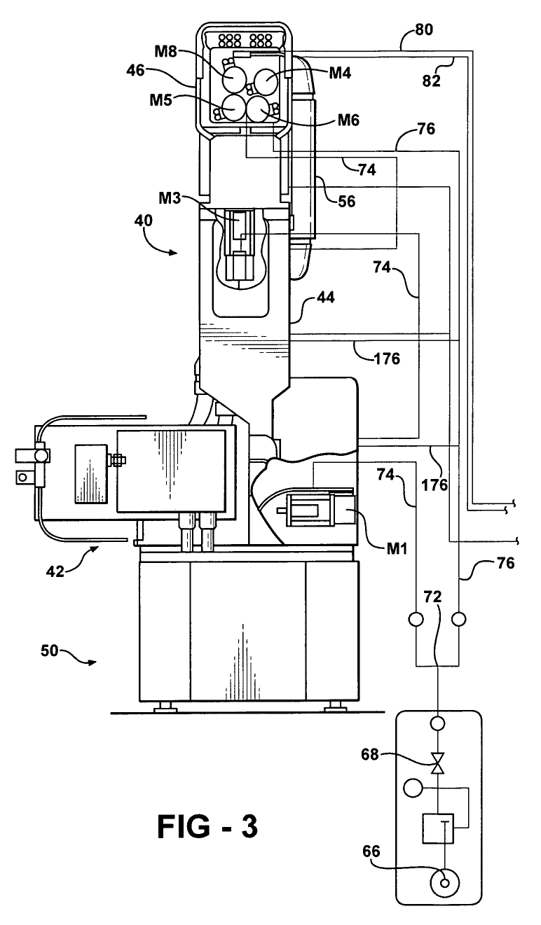

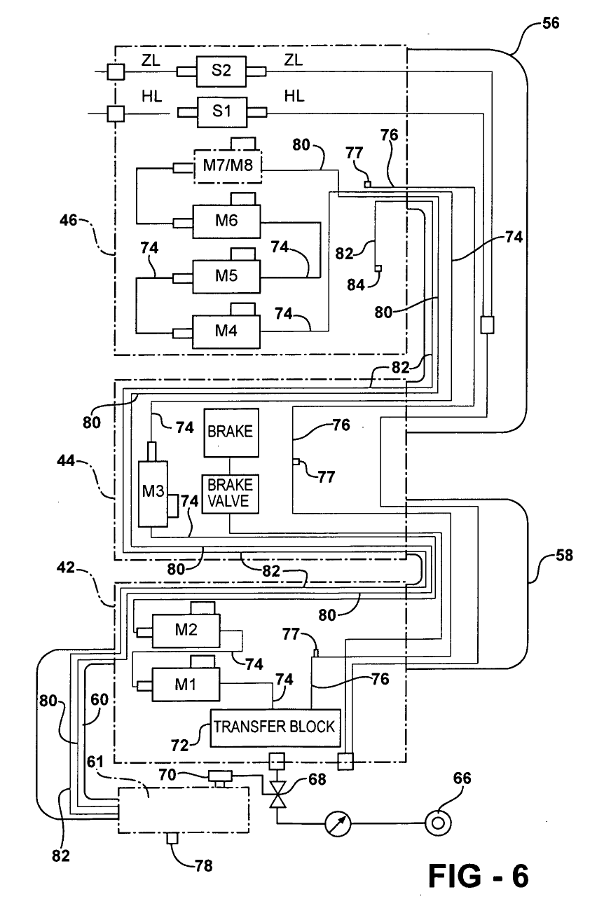

FIGS. 2 and 3 illustrate one possible embodiment of a robotic paint applicator 40 according to the invention. In describing the robotic paint applicator 40, reference will also be made to FIG. 6, which is a schematic illustration of the primary electrical components of the robotic paint applicator and the air circulation and purging system of this invention. The robotic paint applicator 40 includes a base housing or section 42 and an intermediate housing or section 44 mounted on the base section 42. A robot arm 46 includes a wrist 48 at its distal end, which wrist 48 receives a conventional rotary paint atomizer 49. In this embodiment, the base section 42 is mounted on a support section 50, which is supported by the floor of the paint booth 52. As will be understood by those skilled in this art, the paint booth 52 is an enclosed work area including a potentially explosive atmosphere separated and enclosed from the remainder of the paint shop by a wall 54, partially shown in FIG. 2.

This embodiment of the robotic paint applicator 40 includes six to eight explosion proof electric servomotors labeled M1 through M8. Electric servomotors M1 and M2 are located in the base section 42, electric servomotor M3 is located in the intermediate section 44 and electric servomotors M4 through M8 (where the robot includes eight servomotors) are located in the robot arm 46 as shown in FIGS. 2 and 3 and also in FIG. 6. (For clarity, electric servomotors M7 and M8 are combined in FIGS. 3 and 6.) Each of the explosion proof servomotors M1 through M8 is enclosed within the substantially or nearly air-tight enclosures provided by the respective housings of the robot sections 42, 44 and 46. These robot sections 42, 44 and 46 are, as described above, sufficiently airtight to permit purging and to maintain a positive pressure of a non-combustible gas within the enclosure.

As will be understood by those skilled in this art, a robotic paint applicator 40 of the type illustrated in FIGS. 2 and 3 includes numerous components and controls that do not form any part of this invention and will not, therefore, be described in any detail. However, as will be understood by those skilled in this art, the intermediate section 44 is pivotally supported on the base section 42 by a pivot joint 62 and the robot arm 46 is pivotally supported by the pivot joint 64. The base section 42 may be rotatably supported on the support section 50. The electric servomotors M1 through M8 control the movement of the robotic paint applicator 40 including the wrist 48. Thus, the paint atomizer 49 mounted on the wrist 48 may be moved and controlled by the electric servomotors M1 through M8 during application of paint or other coating to a substrate such an automotive body, which is typically transferred through the paint booth 52 on a conveyor (not shown).

In a typical application, the robotic paint applicator 40 is substantially in continuous motion during operation to apply paint to an entire surface of a large substrate. As will also be understood, the housing enclosures 42, 44 and 46 will include other electrical components, such as the solenoid valves S1 and S2 in the robot arm 46 shown in FIG. 6 and wires, switches, etc., which are maintained in a non-combustible or explosion proof atmosphere in the robotic paint applicator 40 as described below. FIGS. 2, 3 and 6 illustrate schematically the air purge and pressurizing system for the robotic paint applicator 40. As best shown in FIG. 6, the purge and pressurizing system includes a source of noncombustible gas or air source 66, which is located outside the paint booth 52 as shown in FIG. 2. The air under pressure is received by a proportional valve 68 controlled by a control unit 70. As set forth above and further described below, the valve 68 may be controlled by the control unit 70 to control the pressure and therefore the volume of air received by the first transfer block 72, which is located by example in the base section 42 of the robotic paint applicator 40. Of course, the transfer block 72 could be located outside the base section 42 in a nearby location such as in the support section 50.

The transfer block 72 divides the air or other non-combustible gas into a first line or conduit 74 and a second line or conduit 76. The air received from the first transfer block 72 is connected to the gas inlet 30 (see FIG. 1) of the first electric servomotor M1. The gas outlet 32 of the first electric servomotor M1 is then connected such that the air from the outlet 32 is sent to the gas inlet 30 of the second electric servomotor M2. Then, the air from the gas outlet 32 of the second electric servomotor M2 is supplied to the gas inlet 30 of the third electric servomotor M3. This serial connection by line or conduit 72 continues through each of the servomotors, in the current embodiment, servomotors M1 through M8. As described previously, explosion proof electric servomotors M1 and M2 are located in the base section 42 of the robotic paint applicator 40, explosion proof electric servomotor M3 is located in the intermediate section 44 of the robotic paint applicator 40, and explosion proof electric servomotors M4 through M8 are located in the arm section 46 of the robotic paint applicator 40. Therefore, conduit 74 extends through a first flexible hose 58 coupling the intermediate section 44 to the base section 42 to reach servomotor M3 from servomotor M2 and extends through a second flexible hose 56 coupling the intermediate section 44 to the arm section 46 to reach servomotors M4-M8 from servomotor M3.

Air expelled from the air outlet 32 of the last servomotor, in this case servomotor M8, is supplied to a first discharge line or conduit 80. The first discharge conduit 80 carries the expelled air from the air outlet 32 of servomotor M8 in the arm section 46 through the second flexible hose 56 to the intermediate section 44 and through the first flexible hose 58 from the intermediate section 44 to the base section 42. The base section 42 is connected with a third flexible hose 60 to a purge monitor 61 (see FIG. 7), which may be located in the support section 50 or any convenient location. More specifically, the first discharge conduit 80 carries the expelled air from the base section 42 through the third flexible hose 60 and into an input channel of the purge monitor 61.

The purge monitor 61 is preferably a 2-channel purge monitor available from Pepperl+Fuchs. As shown in FIG. 6, the purge monitor 61 includes the control unit 70 (either external or internal), which is connected to the proportional valve 68. The purge monitor 61 also includes an exhaust 78 incorporating a one-way valve. If the pressure in the servomotors M1 through M8 falls below a predetermined minimum greater than atmospheric, the valve 68 is controlled to increase the pressure or air flow through the valve 68 to the transfer block 72 to maintain the pressure of the non-combustible gas in the servomotors M1 through M8.

The second line or conduit 76 from the transfer block 72 extends into each of the robot sections 42, 44 and 46 by passing through each of the flexible hoses 56, 58. In each of the robot sections 42, 44 and 46, the conduit 76 includes an outlet 77 that disperses air into the robot sections 42, 44 and 46. A second discharge line or conduit 82 receives air from the robot arm section 46 through an inlet 84. The air travels within the second discharge conduit 82 through the second flexible hose 56 to the intermediate section 44 and through the first flexible hose 58 from the intermediate section 44 to the base section 42 and through the third flexible hose 60 to a second input channel of the purge monitor 61. Similar to the discussion above, the control unit 70 operates such that if the pressure in the housings for the robot sections 42, 44 and 46 falls below a predetermined minimum greater than atmospheric, the valve 68 is controlled to increase the pressure or air flow through the valve 68 to the transfer block 72 to maintain the pressure of non-combustible gas in the housing enclosures 42, 44 and 46 above atmospheric pressure. Maintaining pressure in the section housings and the electric servomotors prevents the entry of combustible gas into these components.

Note that the robotic paint applicator 40 described has separate circulation systems for the air flowing through the explosion proof servomotors M1 through M8 and that flowing through the robot sections 42, 44 and 46. This allows one to separately control the air pressure when first purging and then maintaining a positive pressure of non-combustive gas.

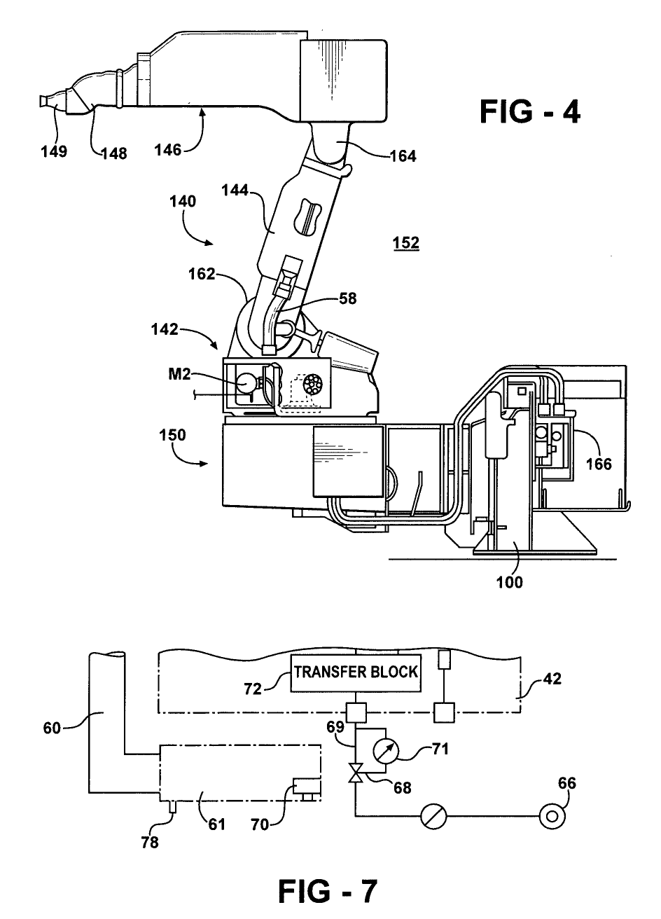

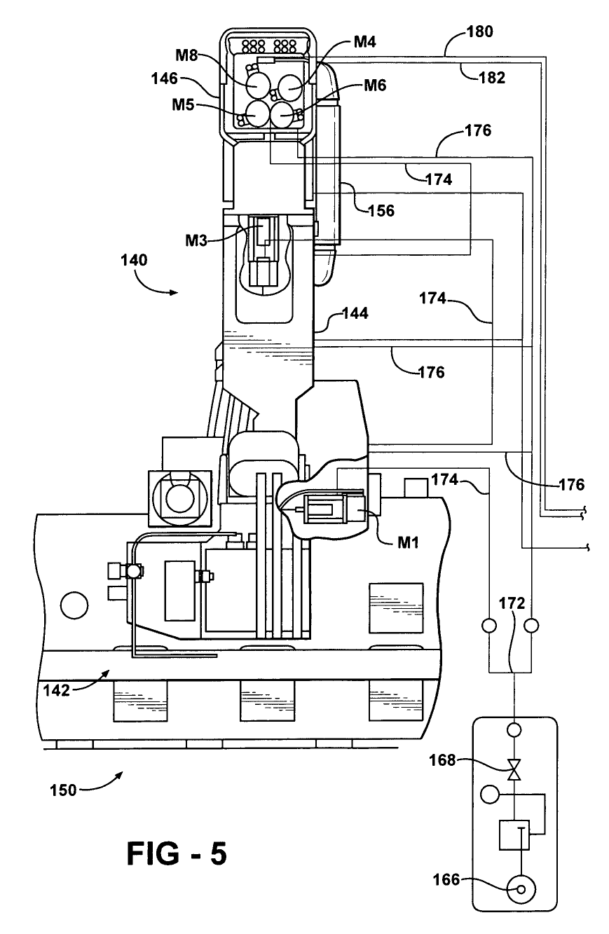

As set forth above, the robotic paint applicator of this invention may be mounted on the floor of the paint booth 52 as shown by robotic paint applicator 40 in FIGS. 2 and 3, or the base section 142 can be supported on a base 150 mounted on a rail 100 (best shown in FIG. 4) for movement with the substrate to be painted through the paint spray booth 152 on a conveyor (not shown). This alternative robotic paint applicator 140 is shown in FIGS. 4 and 5. The air supply and purge system shown in FIG. 6 may also be utilized in the robotic paint applicator 140 shown in FIGS. 4 and 5. Other components of the robotic paint applicator 140 may be identical to the robotic paint applicator 40 described above and have, therefore, been numbered the same in FIGS. 2 and 3 (except for incremented by 100), and no further description is required for a complete understanding of this embodiment.

Having described certain embodiments of the robotic paint applicator, the method of protecting a robotic paint applicator having an explosion proof electric motor from explosion in an enclosed paint booth may now be described. As will be understood from the above descriptions, an electric motor is enclosed in a substantially air-tight enclosure. In a typical application, the enclosure comprises the housings of the base and intermediate section and the robot arm 42, 44 and 46, respectively, wherein the enclosure is sufficiently air-tight to maintain a positive pressure of non-combustible gas, such as 95%. One or more explosion proof electric motors having a substantially air-tight motor housing and a gas inlet and gas outlet, such as the electric servomotor 20 illustrated in FIG. 1, are incorporated into one or more of the robot sections 42, 44 and 46. Each motor housing is purged by circulating non-combustible gas through the motor housings and through the first discharge conduit 80, purging the motor housing and the enclosure of potentially combustible gas. Each robot section 42, 44 and 46 is similarly purged by circulating non-combustible gas through the sections and through the second discharge conduit 82, purging the section 42, 44 and 46 of potentially combustible gas.

More specifically, purging occurs when a non-combustible gas under a first pressure is supplied to either the first servomotor M1 or to the base section 42 under sufficient pressure to circulate the non-combustible gas through the motor housings or through the various robot sections, respectively, purging the motor housing and the enclosure of potentially combustible gas. In a preferred embodiment, air is supplied to the inlet 30 of the servomotor under a pressure between 3 and 5 bars, preferably about 4 bars, and the volume of air supplied to the explosion proof electric servomotor during purging is between 5 and 10 times the volume of the motor housing. Of course, where there is a plurality of electric servomotors, the volume of air supplied to the electric servomotor may be adjusted accordingly. Similar pressures and volumes are supplied to the robot sections to assure complete purging of potentially combustible gas.

After purging, the servomotors can be operated while the air supply and purge system continues to supply non-combustible gas to the electric servomotor housings, connected in series, and to the robot sections, also connected in series. The gas is most commonly supplied at a second pressure less than the first pressure used during purging, but it is sufficient to maintain a positive pressure of non-combustible gas in the motor housings and in the enclosures. An air pressure of about 85 mbar will be sufficient in most cases to assure maintaining a positive air pressure in the motor housings 28 of the servomotors and in the housings enclosing robot sections 42, 44 and 46, preventing entry of potentially combustible gas into the enclosures and the electric servomotor housings.

As will be understood by those skilled in this art, a commercial embodiment of the robotic paint applicator of this invention will include numerous other electrical and pneumatic components including the servo valves S1 and S2 shown in FIG. 6, a brake and brake valve, also shown in FIG. 6, filters and the like which are shown in the drawings to complete the disclosure of the robotic paint applicator, but not described in detail.

FIG. 7 illustrates in schematic form an alternative embodiment of the control and purge system that may be utilized in the robotic paint applicators disclosed herein. This alternative system includes a pressure regulator 71 between the valve 68 and the transfer block 72 that regulates the pressure of the non-combustible gas delivered from the source 66. As will be noted from FIG. 7, the pressure regulator 71 is in parallel with the line 69 between the source of non-combustible gas to the robotic paint applicator. The control 70 may be optionally connected to the main control valve 68 as described above with reference to FIG. 6. The robotic control and purge system illustrated in FIG. 7 may be otherwise identical to the system disclosed in FIG. 6.

Having described preferred embodiments of the robotic paint applicator and method of this invention, it will be understood that various modifications may be made within the purview of the appended claims. For example, the robotic paint applicator of this invention and method is not limited to the disclosed embodiments. The robotic paint applicator may include any number of housing sections or modules, and each section may include any number of explosion proof electric motors depending upon the application. Further, the purge and pressurizing system may be utilized with any electric motor and is, therefore, not limited to an electric servomotor as disclosed and described. As will be understood, the embodiment of the explosion proof electric servomotor disclosed in FIG. 1 is a modification of a conventional electric servomotor to include a housing having gas inlet and outlet ports and the housing has been enlarged to assure circulation of non-combustible gas and purging of the electrical components. Further, the gas inlet and outlet may be located in various portions of the motor housing, but are preferably spaced to assure complete purging. As used herein, the term “paint” is intended to cover any coating that may be applied to a substrate and is not limited to color coatings or conventional paint. A purge and circulation system can be used but is not required for coatings that do not include a potentially explosive carrier or solvent. Finally, non-combustible gas may be any suitable gas, such as nitrogen or a noble gas, but air is preferred for reasons of cost and convenience. Although more expensive, a separate source of non-combustible gas (with separately controlled valves) could be used for each of the servomotors and the robot sections. Similarly, two separate purge monitors could be used instead of the 2-channel purge monitor recommended.

What is claimed is:

1. A robotic paint applicator, comprising:
a plurality of electric motors, each enclosed by a substantially air-tight motor housing and having a gas inlet and a gas outlet;
a robot enclosure supporting a painting tool, the robot enclosure being substantially air-tight and housing at least one electric motor and its respective motor housing;
a source of non-combustible gas operable to supply gas at gas pressures sufficient to purge each motor housing and the robot enclosure and to maintain positive non-combustible gas pressures within each motor housing and the robot enclosure;
a first conduit coupled the source and to a first gas inlet of a first one of the plurality of electric motors for transmitting gas from the source to the plurality of electric motors, the plurality of electric motors serially connected such that each gas inlet other than the first gas inlet is coupled to a gas outlet of an adjacent one of the plurality of electric motors;
a first discharge conduit coupled to an air outlet of a final one of the plurality of electric motors for expelling gas from the plurality of electric motors;
a second conduit coupled to the source and the robot enclosure for transmitting gas from the source to the robot enclosure;
a second discharge conduit coupled to the robot enclosure for expelling gas from the robot enclosure; and
a transfer block for separately controlling a gas pressure within the motor housings and a gas pressure within the robot enclosure, the transfer block located between the source and the first conduit and the source and the second conduit.

2. The robotic paint applicator according to claim 1 wherein each of the plurality of electric motors is an electric servomotor.

3. The robotic paint applicator according to claim 1 wherein the non-combustible gas is at least one of air, nitrogen and a noble gas.

4. The robotic paint applicator according to claim 1 wherein the painting tool is a rotary paint atomizer.

5. The robotic paint applicator according to claim 1, further comprising:
a proportional valve coupled between the source and the transfer block.

6. The robotic paint applicator according to claim 5, further comprising:
a pressure regulator between the proportional valve and the transfer block for regulating the pressure of the non-combustible gas from the source.

7. The robot paint applicator according to claim 5, further comprising:
a control unit controlling the proportional valve.

8. The robotic paint applicator according to claim 1, further comprising:
a purge monitor coupled to receive expelled gas from the first discharge conduit and the second discharge conduit.

9. The robotic paint application according to claim 8 wherein the purge monitor further comprises an exhaust incorporating a one-way valve.

10. The robotic paint applicator according to claim 8, further comprising:
a valve coupled between the source and the transfer block.

11. The robot paint applicator according to claim 10, further comprising:
a control unit coupled to the purge monitor and operable to control the valve to maintain respective gas pressures of the non-combustible gas in the motor housings and in the robot enclosure.

12. The robot paint applicator according to claim 11 wherein the control unit is operable to control the valve to increase a pressure of the non-combustible gas in the motor housings when the purge monitor indicates the pressure has fallen below a predetermined minimum greater than atmospheric pressure.

13. The robot paint applicator according to claim 11 wherein the control unit is operable to control the valve to increase a pressure of the non-combustible gas in the robot enclosure when the purge monitor indicates the pressure has fallen below a predetermined minimum greater than atmospheric pressure.

14. The robotic paint applicator according to claim 1 wherein the robot enclosure comprises a base section, an intermediate section and a robot arm supporting the painting tool, each of the base section, the intermediate section and the robot arm being substantially air-tight and each housing at least one electric motor and its respective motor housing; and wherein the second conduit includes an outlet extending into each of the base section, the intermediate section and the robot arm for transmitting gas from into each of the base section, the intermediate section and the robot arm; and wherein the second discharge conduit receives expelled gas from one of the base section, the intermediate section and the robot arm.
